(19) United States
(12) Patent Application Publication
(10) Pub. No.: US 2012/0275614 A1
(43) Pub. Date: Nov. 1, 2012

(54) NOISE CANCELLATION UNIT

(75) Inventors: Motoaki Kobayashi, Kanagawa (JP); Shinji Takemoto, Kanagawa (JP); Kazuyoshi Maeda, Kanagawa (JP); Mitsuhiro Suzuki, Tokyo (JP); Jun Matsumoto, Kanagawa (JP)

(73) Assignee: SONY CORPORATION, Tokyo (JP)

(21) Appl. No.: 13/450,680

(22) Filed: Apr. 19, 2012

(30) Foreign Application Priority Data
Apr. 28, 2011 (JP) 2011-100511
Apr. 28, 2011 (JP) 2011-100515

(51) Int. Cl. G10K 11/16

(52) U.S. Cl. 381/71.5

(57) ABSTRACT

A noise cancellation unit includes: a duct connected to an outlet of an electronic apparatus and configured to pass an exhaust flow discharged from the outlet therethrough; a first microphone provided to the duct; a speaker provided to the duct downstream of the first microphone; a second microphone provided to the duct downstream of the speaker; a first windscreen wall configured to prevent the exhaust flow from colliding with the first microphone; a second windscreen wall configured to prevent the exhaust flow from colliding with the second microphone; and a signal processing circuit configured to generate, based on outputs of the first microphone and the second microphone, a sound signal for removing a noise included in the exhaust flow and supply the sound signal to the speaker.

### CROSS-REFERENCE TO RELATED APPLICATION

The present application claims priority from Japanese Patent Application Nos. JP 2011-100511 and JP 2011-100515 both filed in the Japanese Patent Office on Apr. 28, 2011, the entire contents of which are incorporated herein by reference.

### BACKGROUND

The present disclosure relates to a noise cancellation unit that reduces noises generated from an electronic apparatus by active noise cancellation.

In electronic apparatuses such as video shooting cameras, a mechanism called active noise cancellation for reducing noises included in an exhaust air, such as a cooling fan, is prevailing. The active noise cancellation is to add, to noises, sound waves in opposite phase (noise cancellation sound) to cancel the noises so that a volume thereof is reduced.

The active noise cancellation mechanism generally includes a noise collection microphone that collects noises, a speaker that emits a noise cancellation sound, and a monitoring microphone that monitors a noise cancellation effect. For example, “Panasonic Projector Catalog” (online), July 2003, (retrieved on Mar. 31, 2011), p. 5, from the Internet (URL: http://takarajima2.sakura.ne.jp/tokutoku/th-d9610j_{—}3.pdf) (hereinafter, referred to as Non-patent Document 1) discloses a projector equipped with an active silencer that includes the noise collection microphone, the speaker, and the monitoring microphone in a duct that passes an exhaust air from a fan therethrough.

Further, in video shooting cameras, there is a case where noises such as an operating sound of a cooling fan become a problem at a time of video shooting. Against such noises, a case that is overlaid on the camera to prevent noises from being leaked to the outside (soundproof blimp) is used frequently.

Since the soundproof blimp is overlaid on the camera, a size thereof is large and a weight thereof is also heavy, which leads to a problem that the soundproof blimp hinders image shooting.

### SUMMARY

However, in the active noise cancellation mechanism as disclosed in Non-patent Document 1, an exhaust flow that passes through the duct collides with the microphones, and therefore pop noises may be generated. As a result, it is difficult for the noise collection microphone and the monitoring microphone to correctly collect sounds and perform effective noise cancellation. Further, originally, the noise collection microphone should collect only noises, but the noise collection microphone collects a sound emitted from the speaker as well as the noises, and therefore there is a fear that noise cancellation performance is limited.

The problems as described above are particularly prominent in the case where the size of the duct is limited. This is because, if a cross-sectional area of the duct is small, a flow rate of the exhaust flow is large, and if the duct is short, a distance between the noise collection microphone and the speaker is not secured.

Further, in order that an active noise canceller performs effective noise cancellation, a duct having a certain length is necessary in the principle of the active noise canceller. Therefore, it has been difficult to mount the active noise canceller on a camera having a limited inner space.

In view of the circumstances as described above, it is desirable to provide a noise cancellation unit capable of performing effective noise cancellation even if the noise cancellation unit has a compact size.

According to an embodiment of the present disclosure, there is provided a noise cancellation unit including a duct, a first microphone, a speaker, a second microphone, a first windscreen wall, a second windscreen wall, and a signal processing circuit.

The duct is connected to an outlet of an electronic apparatus and configured to pass an exhaust flow discharged from the outlet therethrough.

The first microphone is provided to the duct.

The speaker is provided to the duct downstream of the first microphone.

The second microphone is provided to the duct downstream of the speaker.

The first windscreen wall is configured to prevent the exhaust flow from colliding with the first microphone.

The second windscreen wall is configured to prevent the exhaust flow from colliding with the second microphone.

The signal processing circuit is configured to generate, based on outputs of the first microphone and the second microphone, a sound signal for removing a noise included in the exhaust flow and supply the sound signal to the speaker.

With this configuration, based on sounds collected by the first microphone and the second microphone, a noise cancellation sound is determined in the signal processing circuit and emitted from the speaker. Therefore, if sounds collected by the first microphone and the second microphone are improper, noise cancellation is not effectively performed. Here, the noise cancellation unit according to the embodiment of the present disclosure includes a first windscreen wall that prevents an exhaust flow from colliding with the first microphone and a second windscreen wall that prevents the exhaust flow from colliding with the second microphone. Accordingly, pop noises due to collision of the exhaust flow with the first microphone and the second microphone can be prevented from being generated, with the result that an influence on noise cancellation due to the pop noises can be suppressed.

The noise cancellation unit may further include a sound guide wall configured to guide a sound emitted from the speaker toward a downstream side of the duct.

By collecting noises that flow in the duct by the first microphone located upstream of the duct and collecting noises, which have been subjected to noise cancellation, by the second microphone located downstream of the duct, the noise cancellation can effectively function. Therefore, when a noise cancellation sound emitted from the speaker is collected by not only the second microphone but also the first microphone, noise cancellation performance is lowered. In the noise cancellation unit according to the embodiment of the present disclosure, the sound guide wall guides the noise cancellation sound emitted from the speaker toward the second microphone and prevents the noise cancellation sound from arriving at the first microphone, with the result that noise cancellation performance can be prevented from being lowered.

The duct may be extended in a first direction, bent to be inverted in a second direction orthogonal to the first direction, and extended in a third direction opposite to the first direction, the duct having a cross-sectional surface whose aspect ratio is gradually varied through the inversion.

With this configuration, the length of the duct necessary for the noise cancellation can be secured and the noise cancellation unit can be made compact in size. In particular, by gradually varying an aspect ratio of the cross-sectional surface of the duct, the duct can be prevented from bulging in the second direction and a space for attaching the speaker can be secured.

The first windscreen wall may be continuous to an inner wall of the duct upstream of the first microphone and have a shape for shielding the first microphone from an upstream side of the duct, and the second windscreen wall may be continuous to the inner wall of the duct upstream of the second microphone and have a shape for shielding the second microphone from the upstream side of the duct.

With this configuration, the first windscreen wall prevents the exhaust flow from colliding with the first microphone, and the second windscreen wall prevents the exhaust flow from colliding with the second microphone.

The sound guide wall may be continuous to the inner wall of the duct upstream of the speaker and have a shape for covering the speaker from the upstream side of the speaker to a front of the speaker.

With this configuration, the sound guide wall can guide a noise cancellation sound emitted from the speaker toward the second microphone and prevents the noise cancellation sound from arriving at the first microphone.

According to another embodiment of the present disclosure, there is provided a noise cancellation unit including a noise cancellation unit main body and a fixing unit.

The noise cancellation unit main body includes a duct connected to an outlet of a camera and configured to pass an exhaust flow discharged from the outlet therethrough, a first microphone provided to the duct, a speaker provided to the duct downstream of the first microphone, a second microphone provided to the duct downstream of the speaker, and a signal processing circuit configured to generate, based on outputs of the first microphone and the second microphone, a sound signal for removing a noise included in the exhaust flow and supply the sound signal to the speaker.

The fixing unit is configured to detachably fix the noise cancellation unit main body to the camera such that the duct is connected to the outlet.

With this configuration, when an exhaust flow discharged form the outlet of the camera flows into the duct, the first microphone collects noises included in the exhaust flow and outputs a sound signal of the noises to the signal processing circuit. The signal processing circuit multiplies the sound signal generated by the first microphone by a predetermined cancellation characteristic and outputs the resultant sound signal to the speaker. The speaker receives the sound signal output from the signal processing circuit and emits a noise cancellation sound. The second microphone collects a sound that has been subjected to noise cancellation and outputs a sound signal of the sound to the signal processing circuit. The signal processing circuit adjusts the cancellation characteristic on the basis of the sound signal output from the second microphone. The fixing unit detachably fixes the noise cancellation unit main body having the above-mentioned configuration to the camera such that the duct is connected to the outlet, and accordingly the noise cancellation unit can perform active noise cancellation on a sound of the exhaust air from the camera. Further, since the noise cancellation unit is detachable from the camera, the noise cancellation unit can be fitted on the camera as necessary.

The fixing unit may fix the noise cancellation unit main body to the camera via a bracket connected to the camera.

With this configuration, even if a special configuration for fitting the noise cancellation unit on the camera is not provided to the camera, the noise cancellation unit can be fitted on the camera. In other words, the noise cancellation unit according to the embodiment of the present disclosure can be generally fitted on various cameras.

The fixing unit may include a casing configured to accommodate the noise cancellation unit main body, a hook provided to the casing and configured to be rotatably engaged with a shaft provided to the bracket, and a screw hole provided to the casing and through which the noise cancellation unit is screwed to the bracket.

With this configuration, the casing that accommodates the noise cancellation unit main body is rotatably supported by the hook engaged with the shaft serving as a rotation axis. Therefore, a user rotates the casing with the hook being engaged with the shaft, with the result that the screw hole of the casing can be aligned with the screw hole of the bracket, and the noise cancellation unit can be fixed to the bracket without positioning the screw holes.

The duct may be connected to the outlet via an elastic member.

With this configuration, the elastic member is deformed when the casing is screwed to the bracket, and the duct can be reliably connected to the outlet of the camera.

The fixing unit may include a casing configured to accommodate the noise cancellation unit main body, a hook provided to the casing and configured to be rotatably engaged with a shaft provided to the camera, and a screw hole provided to the casing and through which the noise cancellation unit is screwed to the camera.

With this configuration, the casing that accommodates the noise cancellation unit main body is rotatably supported by the hook engaged with the shaft serving as a rotation axis. Therefore, a user rotates the casing with the hook being engaged with the shaft, with the result that the screw hole of the casing can be aligned with the screw hole of the camera, and the noise cancellation unit can be fixed to the camera without positioning the screw holes.

As described above, according to the present disclosure, it is possible to provide a noise cancellation unit capable of performing effective noise cancellation even if the noise cancellation unit has a compact size.

These and other objects, features and advantages of the present disclosure will become more apparent in light of the following detailed description of best mode embodiments thereof, as illustrated in the accompanying drawings.

### BRIEF DESCRIPTION OF DRAWINGS

FIG. 1 is a perspective view of a camera fitted with a noise cancellation unit according to an embodiment of the present disclosure;

FIG. 2 is a top view of the camera fitted with the noise cancellation unit;

FIG. 3 is a front view of the camera fitted with the noise cancellation unit;

FIG. 4 is an exploded perspective view of the camera and the noise cancellation unit;

FIG. 5 is an exploded perspective view of the camera and a bracket;

FIG. 6 is a perspective view of the bracket;

FIG. 7 is a perspective view of a front side of the noise cancellation unit according to the embodiment;

FIG. 8 is a perspective view of a rear side of the noise cancellation unit;

FIG. 9 is an exploded perspective view of the noise cancellation unit;

FIG. 10 is a perspective view of a unit main body of the noise cancellation unit;

FIG. 11 is an exploded perspective view of the unit main body of the noise cancellation unit;

FIG. 12 is a perspective view of a duct main body of the noise cancellation unit;

FIG. 13 is a perspective view of a duct of the noise cancellation unit;

FIG. 14 is a perspective view showing a method of attaching a speaker, a first microphone, and a second microphone to the duct main body of the noise cancellation unit;

FIG. 15 is a front view of the duct main body of the noise cancellation unit;

FIG. 16 is a cross-sectional view of the duct of the noise cancellation unit;

FIGS. 17A and 17B are cross-sectional views of the duct of the noise cancellation unit;

FIG. 18 is a perspective view of a first windscreen wall and the first microphone of the noise cancellation unit;

FIG. 19 is a schematic diagram showing a windscreen effect produced by the first windscreen wall of the noise cancellation unit;

FIG. 20 is a perspective view of a second windscreen wall and the second microphone of the noise cancellation unit;

FIG. 21 is a schematic diagram showing a windscreen effect produced by the second windscreen wall of the noise cancellation unit;

FIG. 22 is a perspective view of a sound guide wall and the speaker of the noise cancellation unit;

FIG. 23 is a schematic diagram showing a sound guide effect produced by the sound guide wall of the noise cancellation unit;

FIGS. 24A and 24B are schematic diagrams each showing a functional configuration of the noise cancellation unit;

FIG. 25 is a graph showing a difference in amount of noise cancellation between a case with the sound guide wall and a case without the sound guide wall;

FIG. 26 is a view showing a method of fitting the camera with the noise cancellation unit;

FIG. 27 is a view showing the method of fitting the camera with the noise cancellation unit;

FIG. 28 is a view showing the method of fitting the camera with the noise cancellation unit;

FIG. 29 is a view showing the noise cancellation unit fitted on the camera; and

FIG. 30 is a diagram showing a connection state of an outlet of the camera and an inlet of the duct of the noise cancellation unit.

### DETAILED DESCRIPTION OF EMBODIMENTS

### <Use Mode of Noise Cancellation Unit>

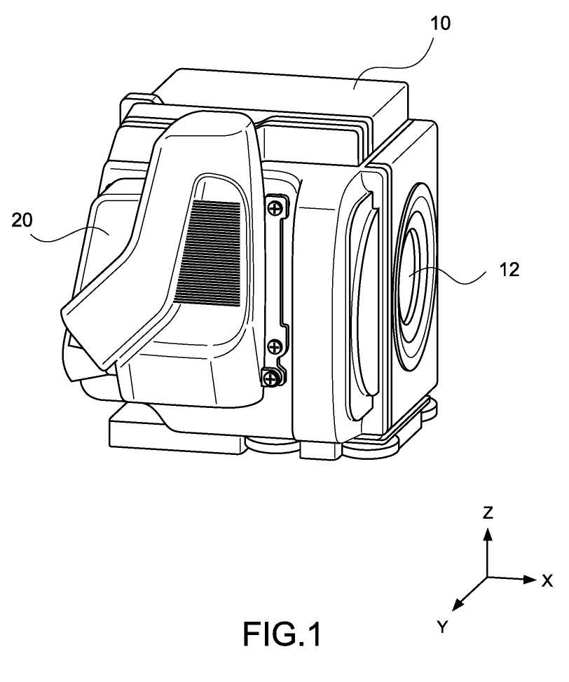

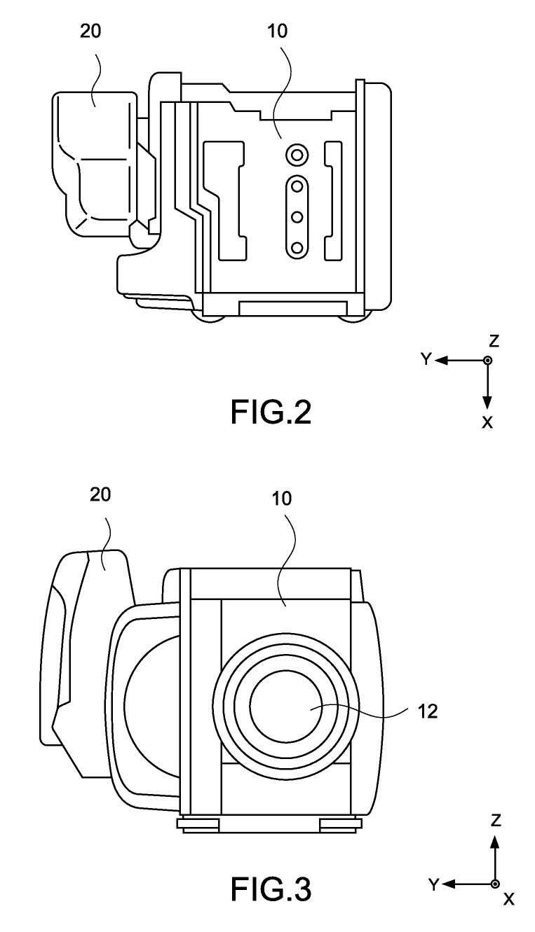

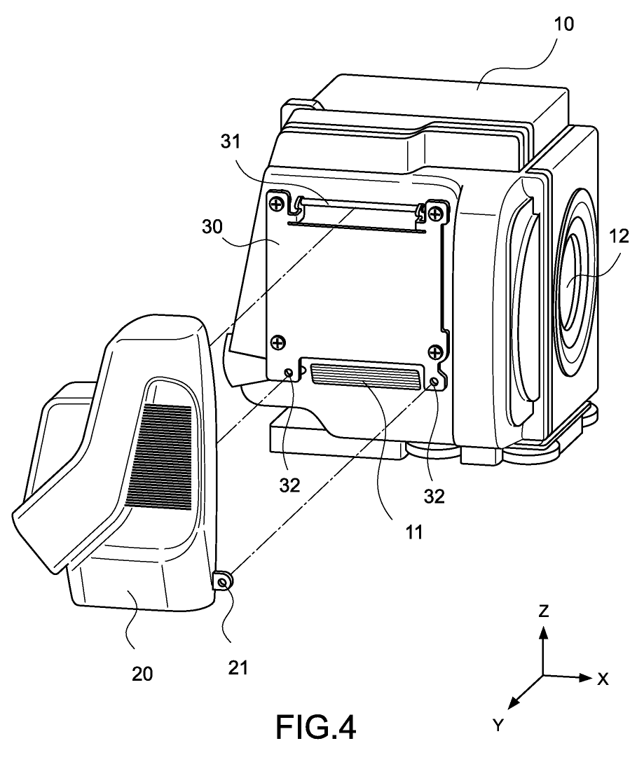

A use mode of a noise cancellation unit according to an embodiment of the present disclosure will be described. The noise cancellation unit is fitted on a video shooting camera (hereinafter, referred to simply as camera) for use. FIG. 1 is a perspective view of a camera 10 fitted with a noise cancellation unit 20. FIG. 2 is a top view of the camera 10, and FIG. 3 is a front view of the camera 10. FIG. 4 is an exploded perspective view of the camera 10 and the noise cancellation unit 20.

As shown in FIG. 4, the camera 10 has an outlet 11, and the noise cancellation unit 20 is configured to be connectable to the outlet 11. Hereinafter, the outlet 11 of the camera 10 is referred to as a camera outlet 11. The noise cancellation unit 20 is for attenuating noises included in an exhaust flow discharged from the camera outlet 11. Cameras capable of being fitted with the noise cancellation unit 20 are not limited to the one shown herein, and various types of cameras can be fitted with the noise cancellation unit 20. The camera 10 shown in FIG. 1 and the like includes a lens attachment portion 12, various switches (not shown), and the like.

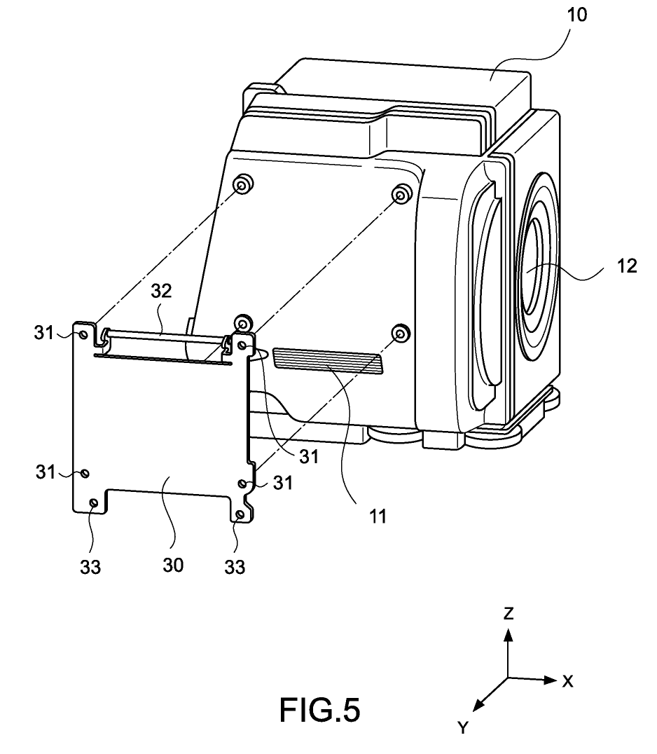

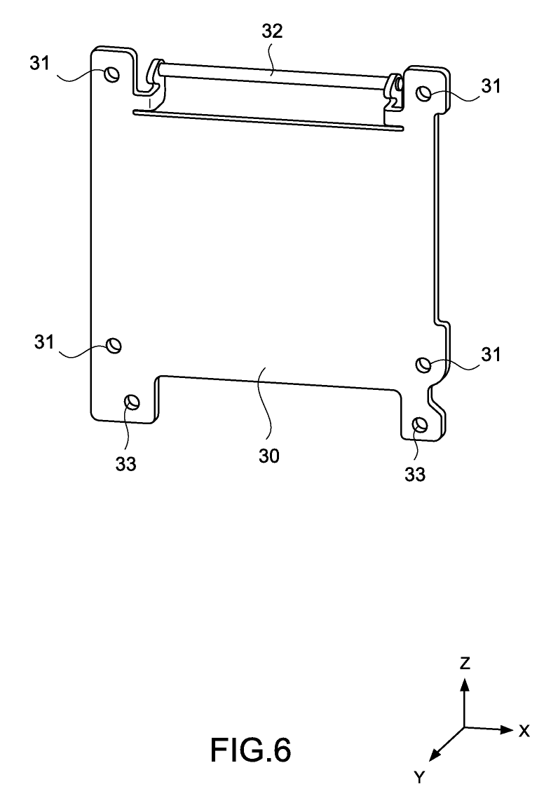

The noise cancellation unit 20 can be fitted on the camera 10 with use of a bracket. FIG. 5 is an exploded perspective view of the camera 10 and the bracket 30, and FIG. 6 is a perspective view of the bracket 30.

As shown in those figures, the bracket 30 is a plate-like member and is connected to the camera 10 so as to face a side wall of the camera 10 on which the outlet 11 is provided. The bracket 30 is provided with screw holes 31, a shaft 32, and female screws 33.

The screw holes 31 are screw holes for screwing the bracket 30 to the camera 10. The arrangement of screw holes or the number of screw holes 31 to be provided is arbitrarily set as long as the bracket 30 can be disposed onto the camera 10 reliably.

The shaft 32 is a bar-like member having a circular cross section and a predetermined length. The shaft 32 is disposed in parallel to the plate-like bracket 30. The shaft is made of a material having abrasion resistance, for example, metal.

The female screws 33 are female screws for screwing the noise cancellation unit 20 to the bracket 30. Although the arrangement of female screws 33 or the number of female screws 33 to be provided is arbitrarily set, it is suitable for the bracket 30 to be placed at a position close to the outlet 11 when the bracket 30 is fitted on the camera 10. This is because a duct (to be described later) of the noise cancellation unit 20 is reliably fixed to the outlet 11.

In this manner, the noise cancellation unit 20 can be connected to the camera 10 via the bracket 30. Therefore, even if the camera 10 is not provided with a special configuration for fitting the noise cancellation unit 20 thereon, the noise cancellation unit 20 can be fitted on the camera. In other words, the noise cancellation unit 20 can be generally fitted on various cameras.

It should be noted that the noise cancellation unit 20 can be fitted on the camera 10 directly without mediation of the bracket 30. In such a case, the configuration corresponding to the shaft 32 and the female screws 33 is necessary for the camera 10.

### <Structure of Noise Cancellation Unit>

A structure of the noise cancellation unit will be described. In the following description, it is assumed that when the noise cancellation unit 20 is fitted on the camera 10, a side of the noise cancellation unit 20 that is opposite to a side facing the camera 10 is a front side of the noise cancellation unit 20, and the side facing the camera 10 is a rear side thereof.

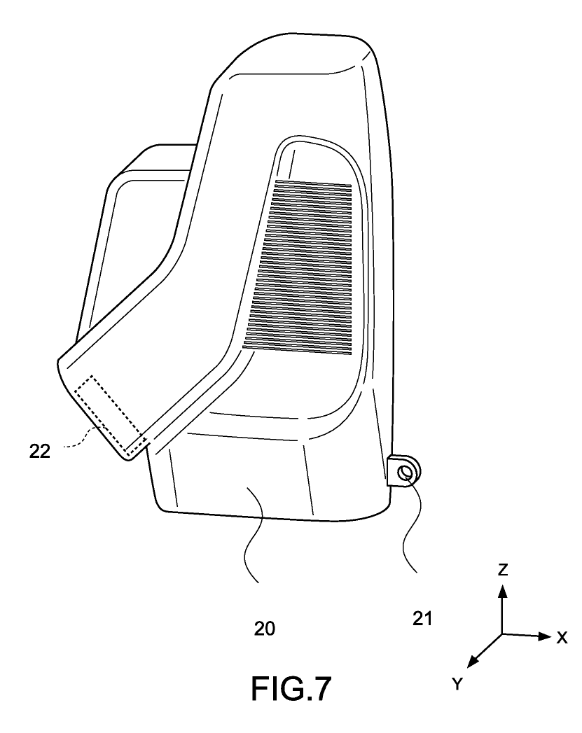

FIG. 7 is a perspective view of the front side of the noise cancellation unit 20. As shown in FIG. 7, the noise cancellation unit 20 is provided with a casing outlet 22. The casing outlet 22 is an outlet for discharging an exhaust air that has been discharged from the camera outlet 11 and has passed through the noise cancellation unit 20. The casing outlet 22 will be described later in detail.

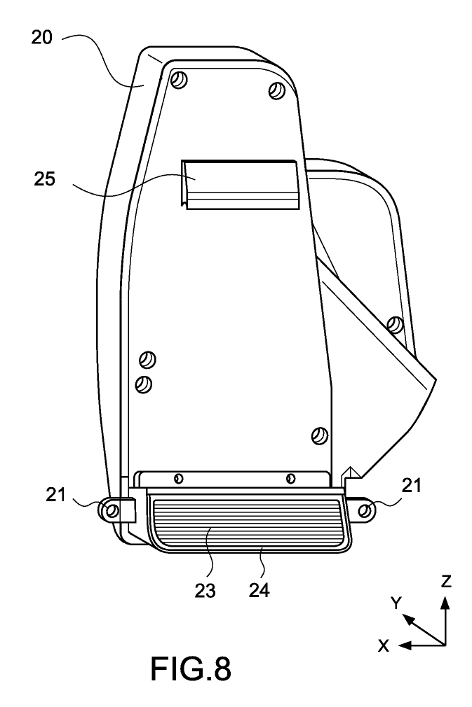

FIG. 8 is a perspective view of the rear side of the noise cancellation unit 20. As shown in FIG. 8, the noise cancellation unit 20 is provided with a casing inlet 23. The casing inlet 23 is formed to have the same size as that of the outlet 11 of the camera 10 and covered with a straightening mesh and the like. Further, provided in the circumference of the casing inlet 23 is an elastic member 24 for bringing the casing inlet 23 into close contact with the outlet 11 of the camera 10. In addition, provided on the rear side of the noise cancellation unit 20 is a hook 25 that is hooked on the shaft 32 of the bracket 30. It should be noted that the width of the hook 25 is suitably set to be substantially equal to the length of the shaft 32.

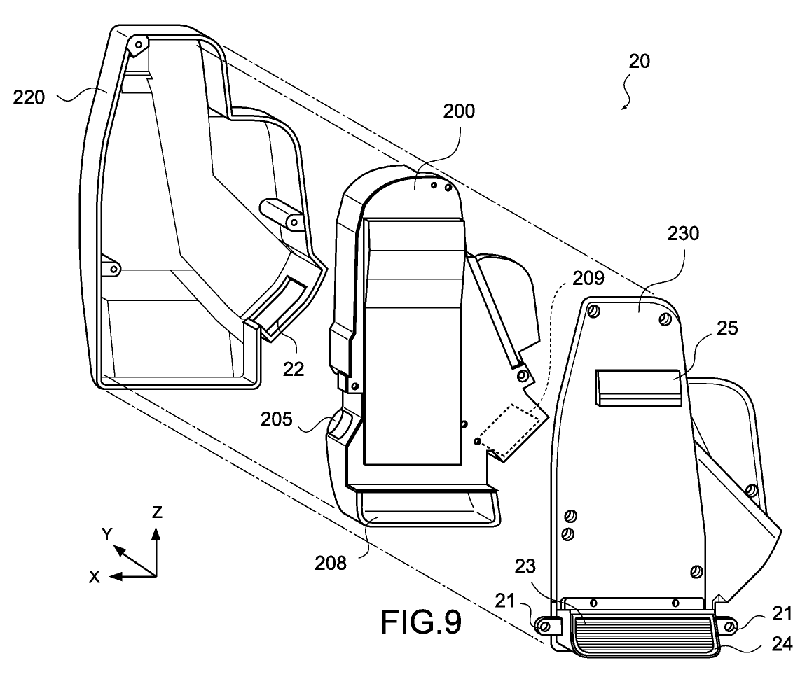

FIG. 9 is an exploded perspective view of the noise cancellation unit 20. As shown in FIG. 9, the noise cancellation unit 20 is constituted of a unit main body 200, a casing cover 220, and a casing lid 230. The unit main body 200 is accommodated in the casing cover 220, and the casing cover 220 is sealed with the casing lid 230. The casing cover 220 corresponds to the front side of the noise cancellation unit 20, and the casing lid 230 corresponds to the rear side of the noise cancellation unit 20.

The casing cover 220 and the casing lid 230 are each formed to have a shape capable of covering the unit main body 200. The casing cover 220 is provided with the casing outlet 22 described above. The casing lid 230 is provided with screw holes 21, and the above-mentioned casing inlet 23, elastic member 24, and hook 25. Further, the casing lid 230 includes a plurality of screw holes for fixing the unit main body 200 to the casing lid 230 and for fixing the casing cover 220 to the casing lid 230.

### <Configuration of Unit Main Body>

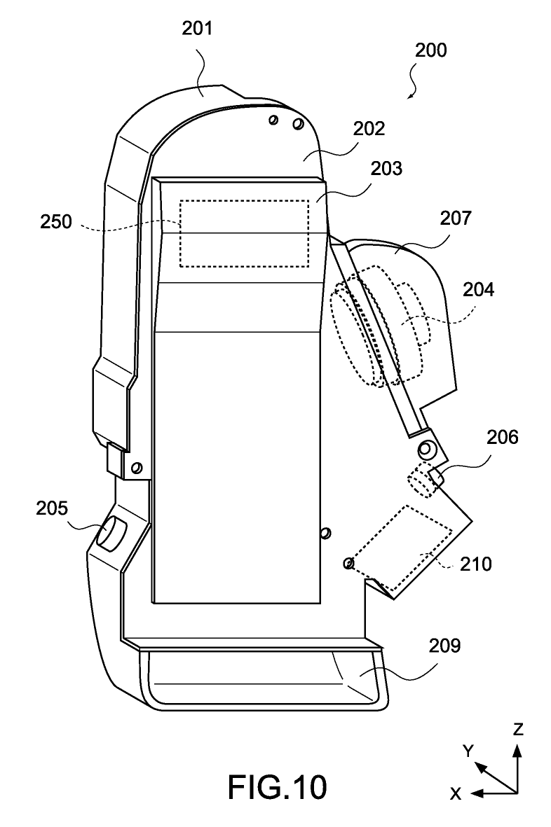

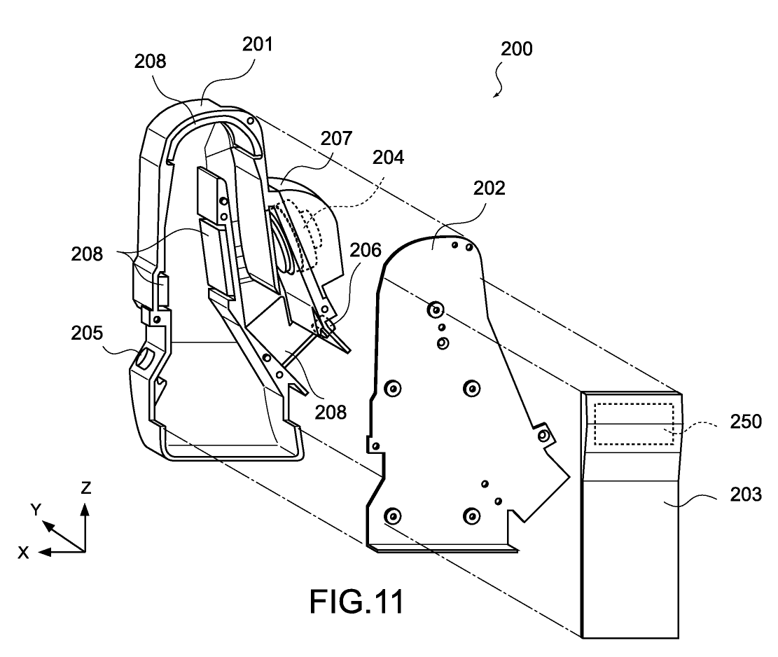

FIG. 10 is a perspective view of the unit main body 200, and FIG. 11 is an exploded perspective view of the unit main body 200. As shown in those figures, the unit main body 200 includes a duct main body 201, a duct lid 202, a circuit board 203, a speaker 204, a first microphone 205, a second microphone 206, a speaker cover 207, and sound-absorbing materials 208. The duct lid 202 is joined to the duct main body 201, and the circuit board 203 is fixed to the duct lid 202. The speaker 204, the first microphone 205, the second microphone 206, the speaker cover 207, and the sound-absorbing materials 208 are each attached to the duct main body 201.

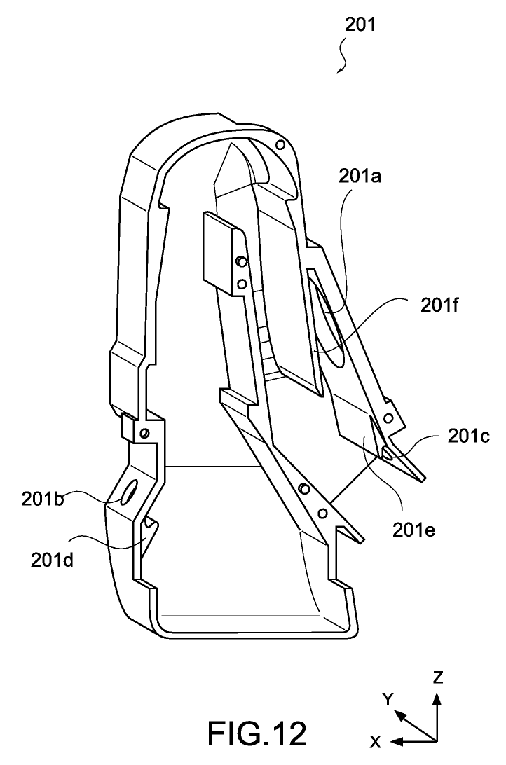

FIG. 12 is a perspective view of the duct main body 201. The duct main body 201 is formed to have the shape to define a “duct”, which will be described later, by being joined with the duct lid 202. Formed in the duct main body 201 are an opening 201a connected with the speaker 204, an opening 201b connected with the first microphone 205, and an opening 201c connected with the second microphone 206. Those openings are formed in order of the opening 201b, the opening 201a, and the opening 201c from upstream to downstream of a duct 240. Further, the duct main body 201 is provided with a first windscreen wall 201d, a second windscreen wall 201e, and a sound guide wall 201f. Those components will be described later in detail.

The duct lid 202 (see FIG. 11) is a plate-like member and joined to the duct main body 201 by screwing. As described above, the duct lid 202 is jointed to the duct main body 201 so that the duct lid 202 and the duct main body 201 form a duct together.

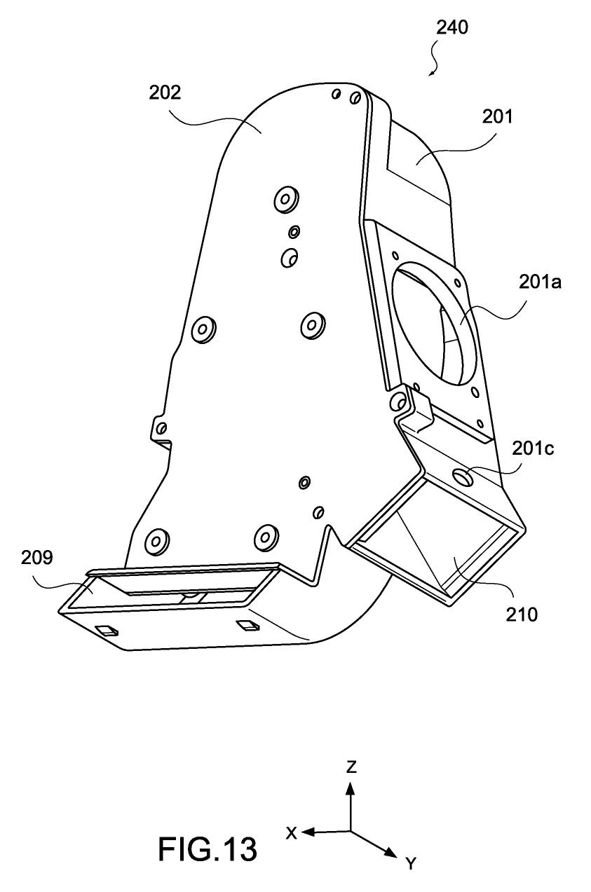

FIG. 13 is a perspective view of a duct 240 formed by the duct main body 201 and the duct lid 202 jointed to each other. As shown in FIG. 13, the duct main body 201 and the duct lid 202 are jointed to each other to form a duct inlet 209 and a duct outlet 210, with the result that the duct 240 communicating from the duct inlet 209 to the duct outlet 210 is formed.

The circuit board 203 (see FIG. 10 and FIG. 11) is fixed to one side of the duct lid 202, which is opposite to the side facing the duct main body 201. Mounted onto the circuit board 203 is a signal processing circuit 250 for controlling electrical components such as the speaker 204, the first microphone 205, and the second microphone 206 that constitute the unit main body 200. The configuration of the signal processing circuit 250 will be described later.

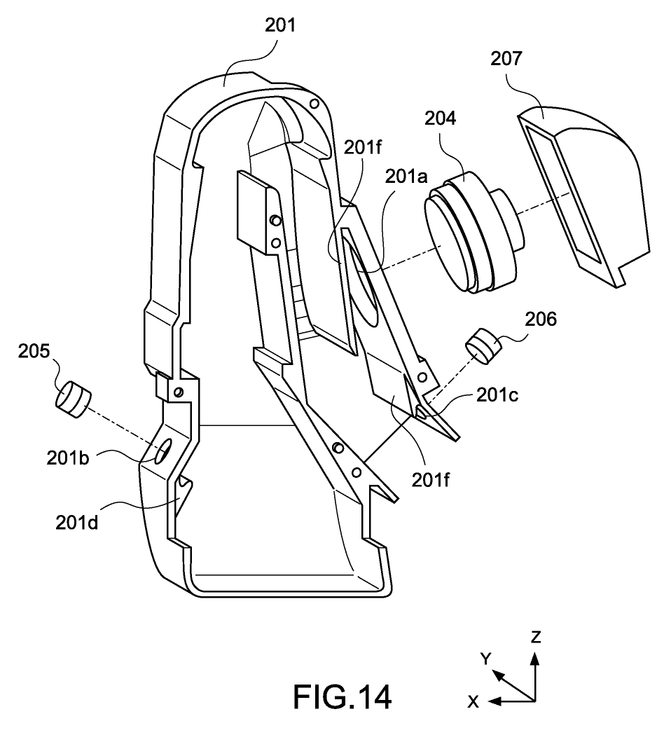

FIG. 14 is a perspective view showing a method of attaching the speaker 204, the first microphone 205, and the second microphone 206 to the duct main body 201.

The speaker 204 is fitted into the opening 201a formed in the duct main body 201. The speaker 204 receives control by the signal processing circuit 250 to emit a predetermined “noise cancellation sound” to the inside of the duct 240. This cancellation sound will be described later. For the speaker 204, a generally-used speaker can be used.

The first microphone 205 is fitted into the opening 201b formed in the duct main body 201. The first microphone 205 collects a sound within the duct 240 and outputs a sound signal thereof to the signal processing circuit 250. For the first microphone 205, a generally-used microphone can be used.

The second microphone 206 is fitted into the opening 201c formed in the duct main body 201. The second microphone 206 collects a sound within the duct 240 and outputs a sound signal thereof to the signal processing circuit 250. For the second microphone 206, a generally-used microphone can be used.

The first microphone 205, the speaker 204, and the second microphone 206 are each attached to the duct main body 201 and accordingly arranged in the stated order from upstream to downstream of the duct 240.

The speaker cover 207 covers the circumference of the speaker 204 attached to the duct main body 201 and prevents sounds emitted from the speaker 204 from being leaked to the outside of the duct 240.

The plurality of sound-absorbing materials 208 are provided to a wall surface of the duct 240. The sound-absorbing materials 208 are each made of a material having sound absorbency, such as a sponge, and each have a shape corresponding a provided position thereof.

### <Shape of Duct>

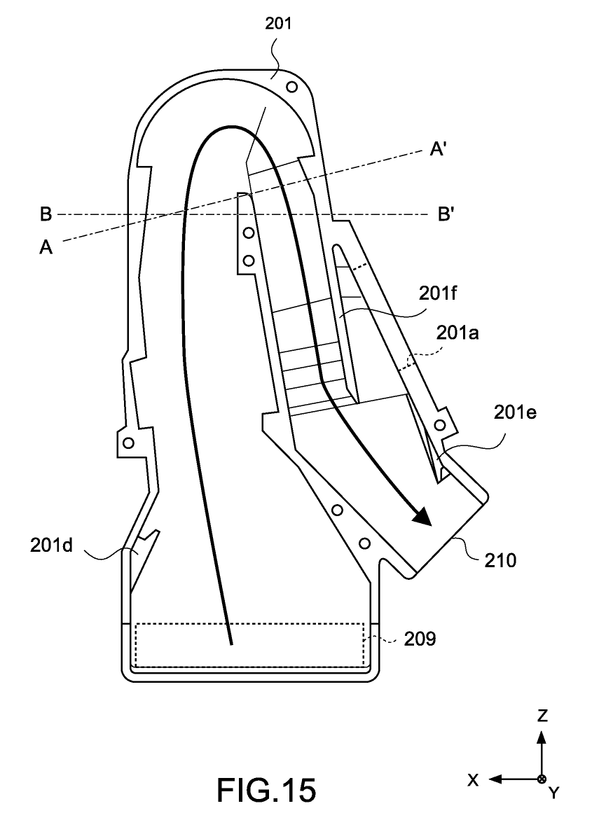

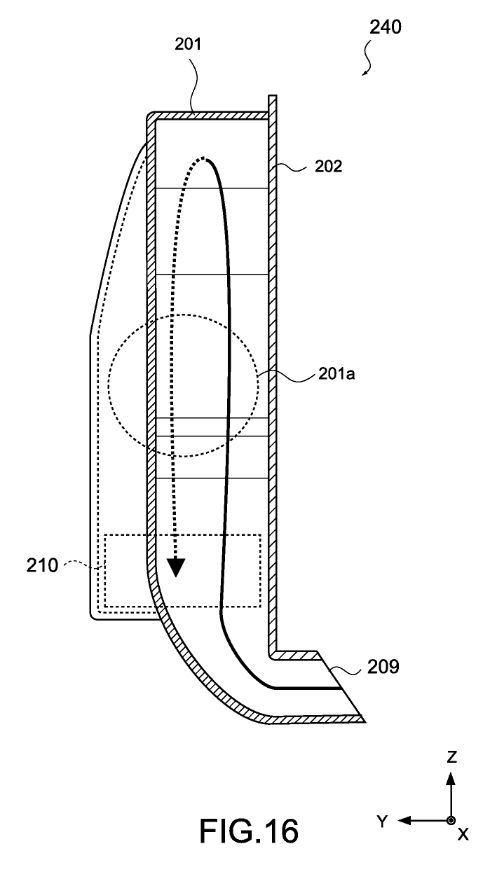

FIG. 15 is a front view of the duct main body 201, and FIG. 16 is a cross-sectional view of the duct 240. In FIG. 15 and FIG. 16, a flow of an exhaust air that flows in the duct 240 (hereinafter, referred to as exhaust flow) is indicated by an arrow. As shown in those figures, the duct 240 has the shape that is extended in a first direction (Z direction), bent to be inverted in a second direction (X direction) orthogonal to the first direction, and extended in a third direction (Z direction) that is a direction opposite to the first direction.

By formation of the duct 240 into such a shape, the length of the duct is ensured and the shape of (the noise cancellation unit 20 for accommodating) the duct 240 can be made compact. The duct is necessary to have a predetermined or more length in order to achieve effective noise cancellation, which will be described later in detail.

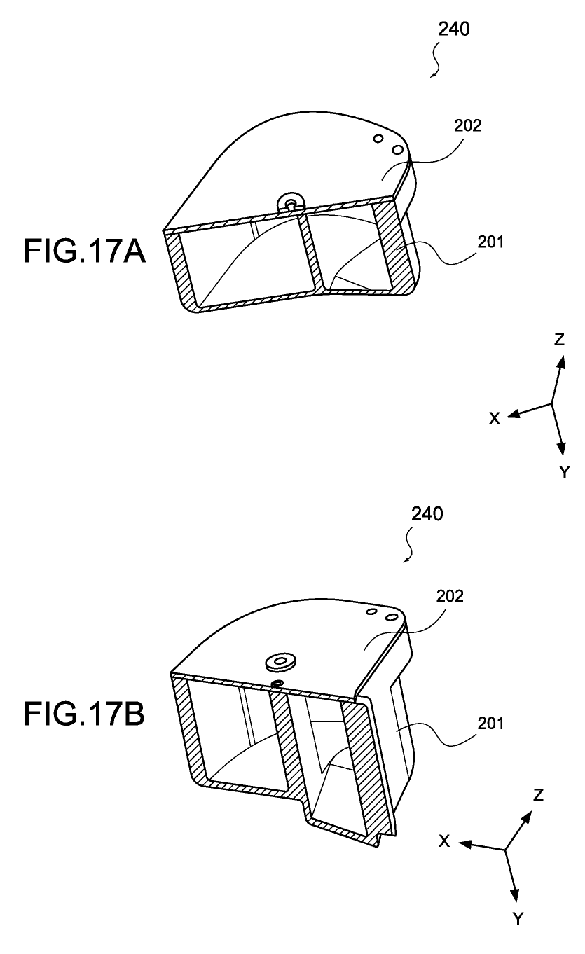

FIGS. 17A and 17B are cross-sectional views of the duct 240. FIG. 17A is a cross-sectional view taken along the line A-A′ of FIG. 15, and FIG. 17B is a cross-sectional view taken along the line B-B′ of FIG. 15. As shown in FIGS. 17A and 17B, a cross-sectional shape of the duct 240 is set to be a shape whose aspect ratio is gradually varied before and after the inversion. By the gradual variation of the cross-sectional shape of the duct, the duct 240 can be prevented from bulging in the second direction (X direction) without changing a cross-sectional area of the duct 240. In addition, the width of the duct 240 (Y direction) is set to be substantially equal to that of the speaker 204, with the result that a space for attaching the speaker 204 (as the opening 201a shown in FIG. 16) can be ensured.

In this manner, the noise cancellation unit 20 according to this embodiment can be made compact in size due to the shape of the duct 240. For example, as shown in FIG. 2 and FIG. 3, the noise cancellation unit 20 can be set to have such a size that the noise cancellation unit 20 does not largely bulge from the camera 10.

It should be noted that in the following description, in the duct 240, the upstream side (duct inlet 209 side) and the downstream side (duct outlet 210 side) are set along the exhaust flow that flows from the duct inlet 209 to the duct outlet 210.

<Windscreen Wall and Sound Guide Wall>

As shown in FIG. 12 and FIG. 14, the duct main body 201 is provided with the first windscreen wall 201d, the second windscreen wall 201e, and the sound guide wall 201f. The first windscreen wall 201d, the second windscreen wall 201e, and the sound guide wall 201f can be formed integrally with the duct main body 201, and can also be formed by joining another member to the duct main body 201.

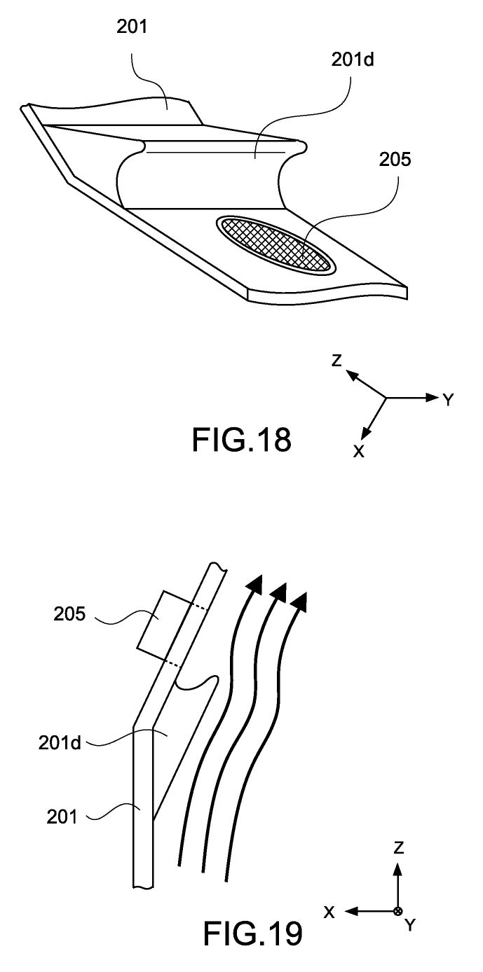

The first windscreen wall 201d is provided upstream of the opening 201b for the first microphone 205, the opening 201b being provided to the duct main body 201. FIG. 18 is a perspective view of the first windscreen wall 201d and the first microphone 205. As shown in FIG. 18, the first windscreen wall 201d is formed to be continuous to an inner wall of the duct 240 upstream of the first microphone 205 and to have a shape for shielding the first microphone 205 from the upstream side of the duct 240. Further, the first windscreen wall 201d is formed to have a smooth shape at the upstream side thereof in order to prevent a sound from being generated when the exhaust flow collides with the first windscreen wall 201d.

FIG. 19 is a schematic view showing a windscreen effect produced by the first windscreen wall 201d. FIG. 19 schematically shows the exhaust flow by arrows. As shown in FIG. 19, the first windscreen wall 201d prevents the exhaust flow from colliding with the first microphone 205 and prevents a pop noise (sound generated when an airflow collides with the microphone) from being generated. The shape of the first windscreen wall 201d is not limited to that shown in the figures and can be such a size that the exhaust flow is prevented from colliding with the first microphone 205.

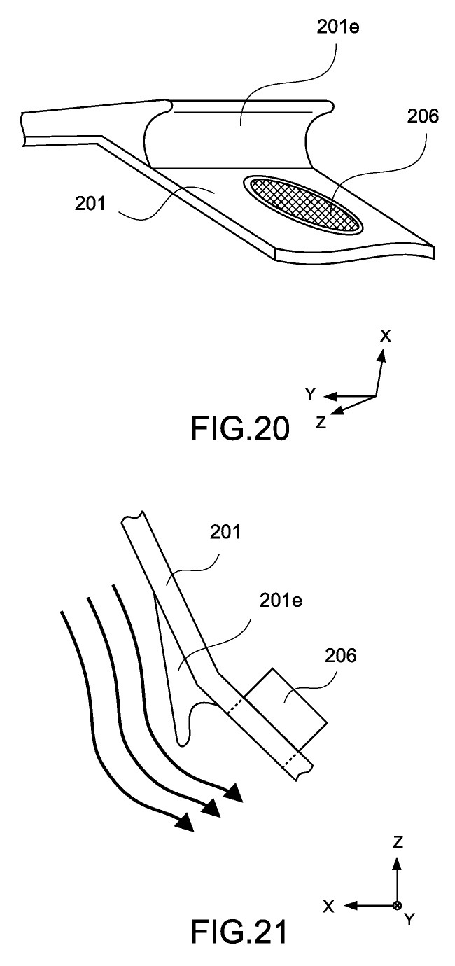

The second windscreen wall 201e is provided upstream of the opening 201c for the second microphone 206, the opening 201c being provided to the duct main body 201. FIG. 20 is a perspective view of the second windscreen wall 201e and the second microphone 206. As shown in FIG. 20, the second windscreen wall 201e is formed to be continuous to the inner wall of the duct 240 upstream of the second microphone 206 and to have a shape for shielding the second microphone 206 from the upstream side of the duct 240. Further, the second windscreen wall 201e is formed to have a smooth shape at the upstream side thereof in order to prevent a sound from being generated when the exhaust flow collides with the second windscreen wall 201e.

FIG. 21 is a schematic view showing a windscreen effect produced by the second windscreen wall 201e. FIG. 21 schematically shows the exhaust flow by arrows. As shown in FIG. 21, the second windscreen wall 201e prevents the exhaust flow from colliding with the second microphone 206 and prevents a pop noise from being generated. The shape of the second windscreen wall 201e is not limited to that shown in the figures and can be such a size that the exhaust flow is prevented from colliding against the second microphone 206.

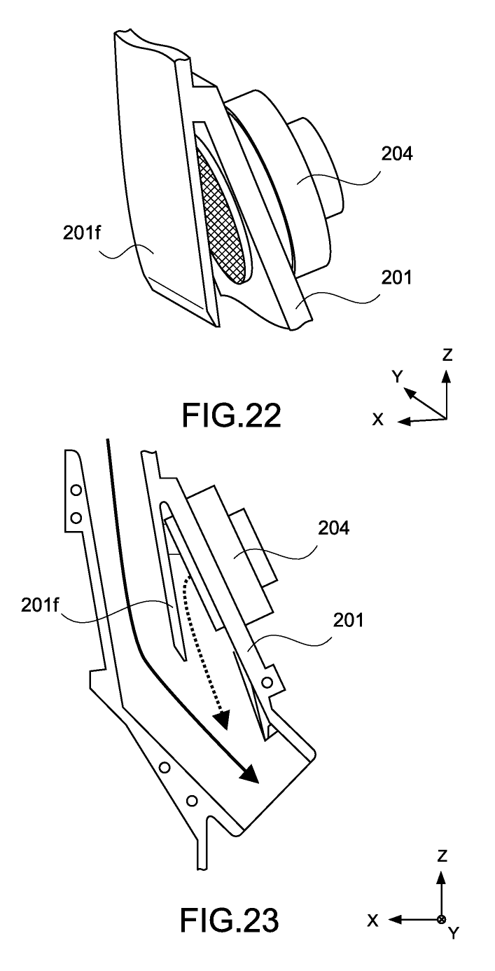

The sound guide wall 201f is provided upstream of the opening 201a for the speaker 204, the opening 201a being provided to the duct main body 201. FIG. 22 is a perspective view of the sound guide wall 201f and the speaker 204. As shown in FIG. 22, the sound guide wall 201f is formed to be continuous to the inner wall of the duct 240 upstream of the speaker 204 and to have a shape for covering the speaker 204 from the upstream side of the speaker 204 to the front of the speaker 204.

FIG. 23 is a schematic diagram showing a sound guide effect produced by the sound guide wall 201f. As shown in FIG. 23, a noise cancellation sound emitted from the speaker 204 (indicated by a dashed arrow in FIG. 23) is guided by the sound guide wall 201f, and almost all the noise cancellation sound is guided to the downstream side of the duct 240 to meet the exhaust flow (indicated by a solid arrow in FIG. 23). The shape of the sound guide wall 201f is not limited to that shown in the figures and can be such a size that the sound emitted from the speaker 204 is guided to the downstream side of the duct 240.

### <Operation of Noise Cancellation Unit>

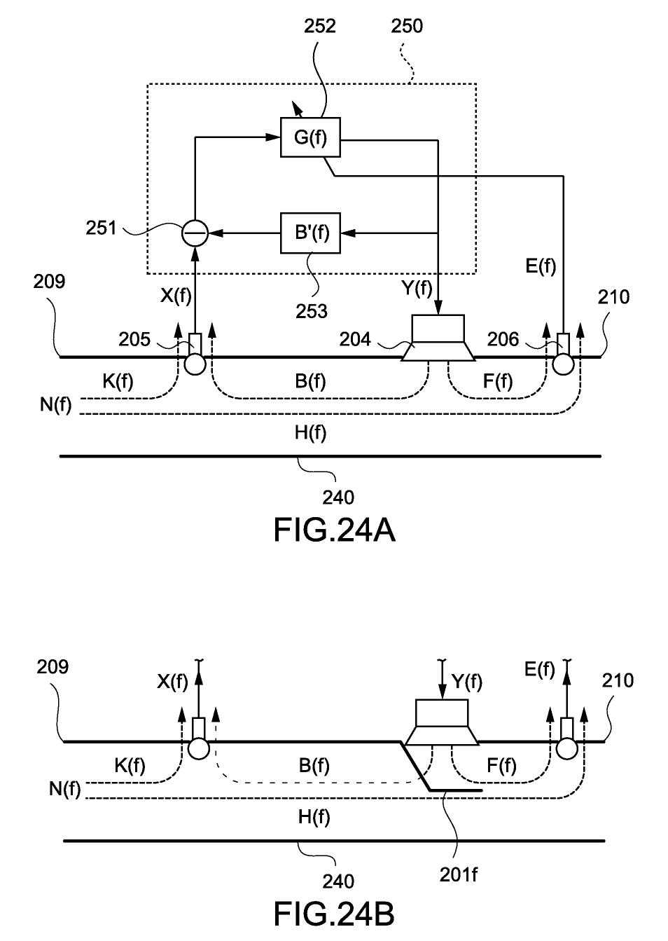

FIGS. 24A and 24B are schematic diagrams each showing a functional configuration of the noise cancellation unit 20. FIG. 24A shows a functional configuration in the case where the effect produced by the sound guide wall 201f is excluded, and FIG. 24B shows a functional configuration in the case where the effect produced by the sound guide wall 201f is taken into consideration. Description will first be given on the case where the effect produced by the sound guide wall 201f is excluded, as shown in FIG. 24A.

As shown in FIG. 24A, the signal processing circuit 250 includes a subtraction section 251, a cancellation-characteristic generation section 252, and a transmission-characteristic estimation section 253. The configuration of those components may be realized by hardware or software.

An operation of the noise cancellation unit 20 will be schematically described below. The first microphone 205 provided in the vicinity of the duct inlet 209 collects noises that flow from the duct inlet 209 into the duct 240 and outputs a sound signal of the noises to the signal processing circuit 250. The signal processing circuit 250 multiplies, by a predetermined cancellation characteristic, the sound signal generated by the first microphone 205 and outputs the resultant sound signal to the speaker 204 provided in the vicinity of the duct outlet 210. The speaker 204 receives the sound signal output from the signal processing circuit 250 and emits a noise cancellation sound (hereinafter, referred to as cancellation sound). The second microphone 206 provided in the vicinity of the duct outlet 210 collects a sound that have been subjected to noise cancellation and outputs a sound signal of the sound to the signal processing circuit 250. The signal processing circuit 250 adjusts a cancellation characteristic based on the sound signal output from the second microphone.

Hereinafter, a noise that is generated in the camera 10 and flows in from the duct inlet 209 is referred to as a noise N(f), and a transmission characteristic up to when the noise N(f) is collected by the first microphone 205 is referred to as a characteristic K(f). Further, a cancellation sound emitted from the speaker 204 is referred to as a cancellation sound Y(f), and a transmission characteristic up to when the cancellation sound Y(f) is collected by the first microphone 205 is referred to as a characteristic B(f). Furthermore, a transmission characteristic up to when the cancellation sound Y(f) is collected by the second microphone 206 is referred to as a characteristic F(f), and a transmission characteristic up to when the noise N(f) is collected by the second microphone 206 is referred to as a characteristic H(f).

Accordingly, a sound X(f) collected by the first microphone 205 is represented by Expression 1 below.

X(f)=N(f)K(f)+Y(f)B(f) (Expression 1)

Further, a sound E(f) collected by the second microphone 206 is represented by Expression 2 below.

E(f)=N(f)H(f)+Y(f)F(f) (Expression 2)

Here, the first microphone 205 should collect only the noise (N(f)K(f)), but the cancellation sound (Y(f)B(f)) is mixed with the noise (N(f)K(f)) as described above and the cancellation characteristic is thus influenced. Therefore, the characteristic B(f) is determined in advance and an estimated characteristic B′(f) thereof is calculated. By removing a sound Y(f)B′(f) derived from the speaker 204, which is estimated to be included in the sound X(f), from the sound X(f) collected by the first microphone 205, the cancellation characteristic can be prevented from being degraded.

The signal processing circuit 250 multiplies, by the cancellation characteristic described above, a sound (X(f)−Y(f)B′(f)) obtained by removing the sound Y(f)B′(f) derived from the speaker 204 from the sound X(f) collected by the first microphone 205. Assuming that the cancellation characteristic is a characteristic G(f), the sound Y(f) that is output from the signal processing circuit 250 to the speaker 204 and then emitted can be represented by Expression 3 below.

Y(f)={X(f)−Y(f)B′(f)}G(f) (Expression 3)

Further, when Expression 1 is substituted into Expression 3, Expression 4 below is obtained.

Y(f)={N(f)K(f)+Y(f)B(f)−Y(f)B′(f)}G(f) (Expression 4)

In consideration of the above, a specific operation of the noise cancellation unit 20 will be described. The first microphone 205 collects the sound X(f) and outputs the sound X(f) to the subtraction section 251. Further, the transmission-characteristic estimation section 253 calculates the sound Y(f)B′(f) described above and outputs the sound Y(f)B′(f) to the subtraction section 251. The subtraction section 251 subtracts the sound Y(f)B′(f) from the sound X(f) and outputs the resultant sound to the cancellation-characteristic generation section 252. The cancellation-characteristic generation section 252 multiplies the sound (X(f)−Y(f)B′(f)) by the cancellation characteristic G(f) to generate a sound Y(f), and outputs the sound Y(f) to the speaker 204. The transmission-characteristic estimation section 253 acquires the sound (f) and uses the sound (f) for calculating the sound Y(f)B′(f). The second microphone 206 collects the sound E(f) described above and outputs the sound E(f) to the cancellation-characteristic generation section 252.

The cancellation-characteristic generation section 252 adjusts the cancellation characteristic G(f) such that the sound E(f) approaches zero. Here, assuming that an ideal cancellation characteristic determined by the cancellation-characteristic generation section 252 (hereinafter, referred to as an ideal cancellation characteristic) is a characteristic G_{ideal}(f), the following Expression 5 and Expression 6 are established.

N(f)H(f)−Y(f)F(f)=0 (Expression 5)

Y(f)={N(f)K(f)+Y(f)B(f)−Y(f)B′(f)}G_{ideal}(f) (Expression 6)

The following Expression 7 is drawn from Expression 5 and Expression 6.

G_{ideal}(f)=H(f)/[F(f)K(f)+H(f){B(f)−B′(f)}] (Expression 7)

Here, the duct 240 can be assumed as an acoustic tube such as a whistle, and sound wave reflection occurs at opening ends thereof, that is, at the duct inlet 209 and the duct outlet 210. Accordingly, the characteristics F(f), H(f), B(f), and K(f) in Expression 7 described above become complex, and the ideal cancellation characteristic G_{ideal}(f) becomes more complex because the ideal cancellation characteristic G_{ideal}(f) includes reciprocals of those characteristics. Therefore, the ideal cancellation characteristic G_{ideal}(f) becomes an acausal and unfeasible characteristic that includes a response at t<0 or becomes an unstable characteristic including an infinite gain by a division by zero. As a result, a feasible cancellation characteristic G(f) is largely different from the ideal cancellation characteristic G_{ideal}(f), and there is a fear that noise cancellation performance is degraded.

Therefore, if the influence due to the complexity of the characteristics F(f), H(f), B(f), and K(f) described above can be reduced, the cancellation characteristic G(f) can be caused to approach the ideal cancellation characteristic G_{ideal}(f), and the noise cancellation performance can be prevented from being degraded.

First, if the first microphone 205 is arranged close to the duct inlet 209, the characteristic K(f) becomes flat and the influence due to the complexity can be reduced.

Further, the complexity of the characteristics F(f), H(f), and B(f) can be reduced by the effect produced by the sound guide wall 201f. Hereinafter, as shown in FIG. 24B, a functional configuration of the noise cancellation unit 20 in the case where the effect produced by the sound guide wall 201f is taken into consideration will be described. It should be noted that in FIG. 24B, the signal processing circuit 250 is the same as that in FIG. 24A, and therefore illustration thereof is omitted.

As shown in FIG. 24B, by the sound guide wall 201f, the cancellation sound Y(f) emitted from the speaker 204 is guided toward the downstream side of the duct 240. With this configuration, the characteristic B(f) can be caused to approach zero and the characteristic F(f) can be made flat at the same time. Therefore, the influence due to the complexity of the characteristics B(f) and F(f) can be reduced. Further, by the characteristic B(f) approaching zero, a characteristic (B(f)−B′(f)) as a difference between the characteristic B(f) and its estimated characteristic B′(f) can be caused to approach zero, with the result that the influence due to the complexity of the characteristic H(f) can be reduced in Expression 7. In other words, by the sound guide wall 201f, the influence due to the complexity of the characteristics F(f), H(f), and B(f) can be reduced, and the cancellation characteristic G(f) can be caused to approach the ideal cancellation characteristic G_{ideal}(f).

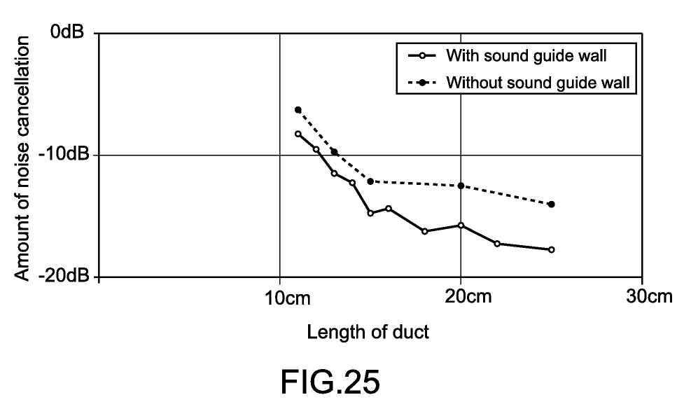

As described above, in the noise cancellation unit 20, the sound guide wall 201f can prevent the noise cancellation performance from being degraded. FIG. 25 is a graph showing a difference in amount of noise cancellation based on whether the sound guide wall 201f is provided or not. The graph of FIG. 25 shows an amount of noise cancellation in ducts having various lengths. A solid line in the graph shows a case where the sound guide wall is provided, and a broken line in the graph shows a case where the sound guide wall is not provided. Based on the graph shown in FIG. 25, it can be said that the sound guide wall improves noise cancellation performance. Further, based on the graph shown in FIG. 25, it can be said that a longer duct provides a larger amount of noise cancellation.

Further, the first windscreen wall 201d and the second windscreen wall 201e will be described. As described above, the first microphone 205 and the second microphone 206 collect the sound X(f) and the sound E(f), respectively, in the exhaust flow that flows in the duct 240. Therefore, when the exhaust flow collides with the first microphone 205 and the second microphone 206, pop noises generated thereby are added to the sound X(f) and the sound E(f), which leas to malfunction of the noise cancellation.

Here, in the noise cancellation unit 20 according to this embodiment, as shown in FIG. 19 and FIG. 21, the first windscreen wall 201d and the second windscreen wall 201e prevent the exhaust flow from colliding with the first microphone 205 and the second microphone 206, with the result that pop noises are prevented from being generated, and noise cancellation can be effectively performed.

As described above, in the noise cancellation unit according to this embodiment, the first windscreen wall 201d and the second windscreen wall 201e can prevent occurrence of an influence due to collision of an exhaust flow with the first microphone 205 and the second microphone 206. Accordingly, the noise cancellation unit 20 can effectively perform noise cancellation even in the case where a cross-sectional area of the duct 204 is small and a flow rate of the exhaust flow is large.

Further, in the noise cancellation unit 20, the sound guide wall 201f can prevent occurrence of an influence caused by collecting a cancellation sound emitted from the speaker 204 by the first microphone 205. Accordingly, the noise cancellation unit 20 can prevent noise cancellation performance from being lowered even in the case where a distance between the first microphone 205 and the speaker 204 is short.

Furthermore, the noise cancellation unit 20 can be made compact in size due to the shape of the duct 240. Therefore, the noise cancellation unit 20 can perform effective noise cancellation by the first windscreen wall 201d, the second windscreen wall 201e, and the sound guide wall 201f even in the case where the noise cancellation unit 20 has a compact size.

The noise cancellation unit 20 has the configuration as described above. As described above, the signal processing circuit 250 makes multiplication by a cancellation characteristic on the basis of sounds collected by the first microphone 205 and the second microphone 206. Therefore, when a cancellation sound emitted from the speaker 204 is directly collected by the first microphone 205 and the second microphone 206, the signal processing circuit 250 may not calculate an effective cancellation characteristic. For that reason, the first microphone 205 and the second microphone 206 are necessary to be spaced apart from the speaker 204, that is, the duct 240 is necessary to have a certain length. Further, in order that the noise cancellation unit 20 may effectively function, the casing inlet 23 that communicates with the duct inlet 209 is necessary to be reliably connected to the outlet 11 of the camera 10.

### <Fitting Method for Noise Cancellation Unit>

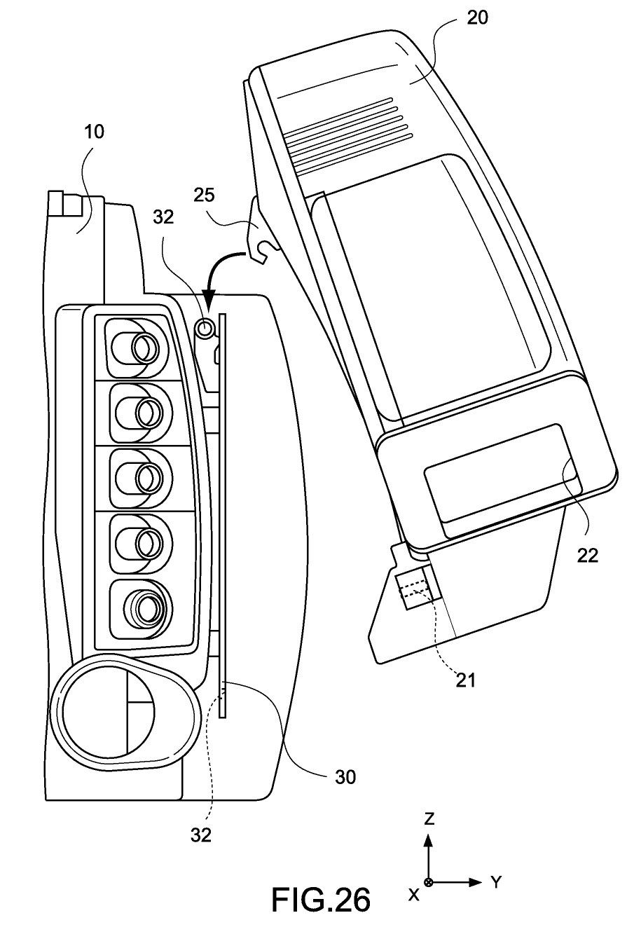

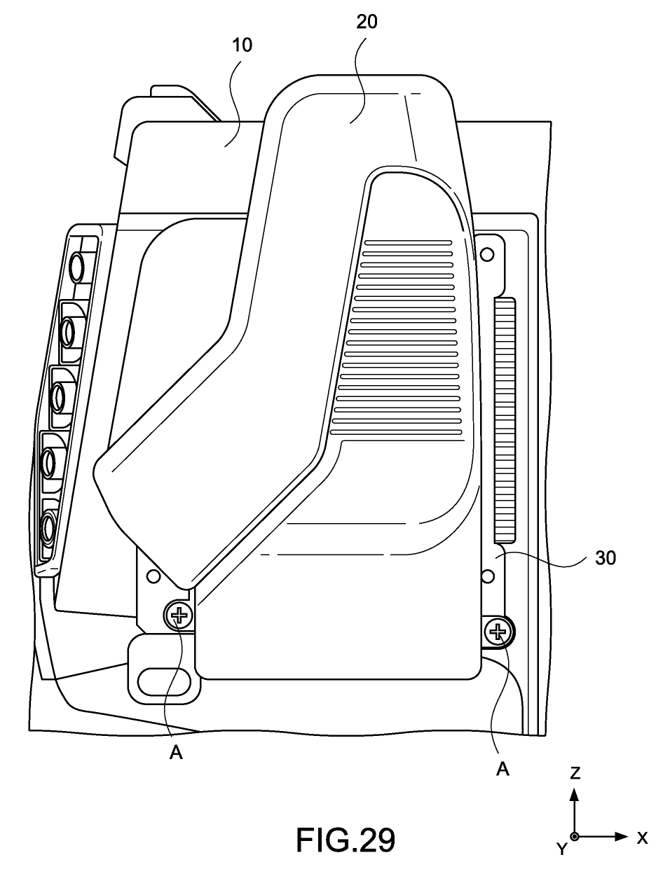

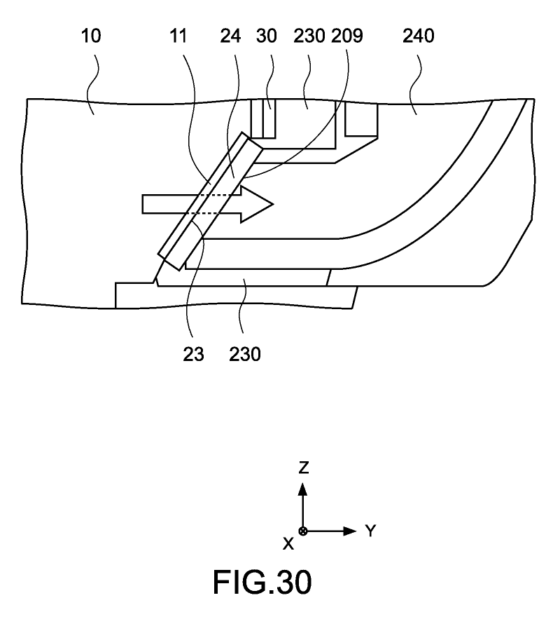

A method of fitting the camera 10 with the noise cancellation unit 20 via the bracket 30 will be described. FIG. 26 to FIG. 28 are views showing a method of fitting the camera 10 with the noise cancellation unit 20, and FIG. 29 is a view showing the noise cancellation unit 20 fitted on the camera 10. FIG. 30 is a diagram showing a connection state of the outlet 11 of the camera 10 and the duct inlet 209 of the noise cancellation unit 20.

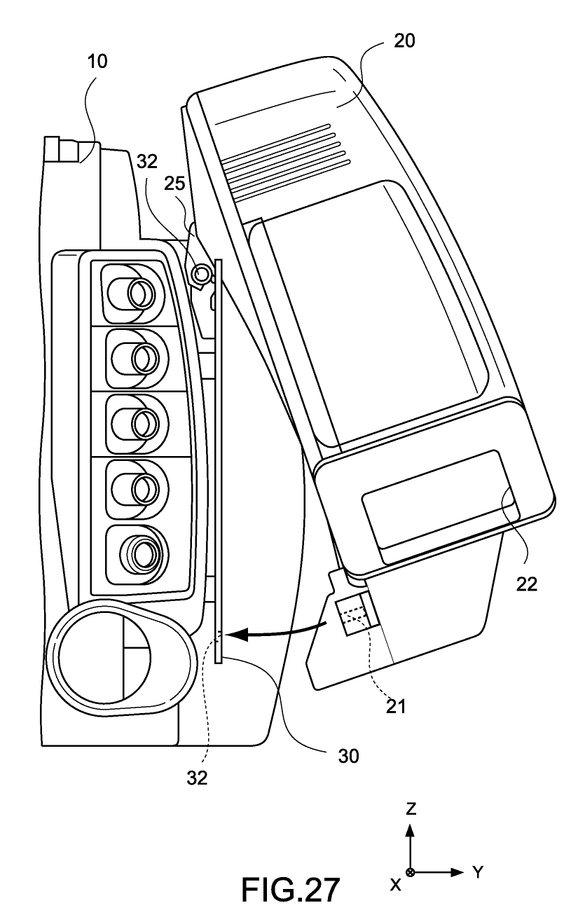

As shown in FIG. 26, the hook 25 provided to the noise cancellation unit 20 on the rear side thereof is hooked to the shaft 32 of the bracket 30, and as shown in FIG. 27, the hook 25 is engaged with the shaft 32. At that time, when the noise cancellation unit 20 is tilted with respect to the bracket 30 as shown in FIGS. 26 and 27, the noise cancellation unit 20 does not interfere with the bracket 30 and accordingly can be easily hooked to the shaft 32.

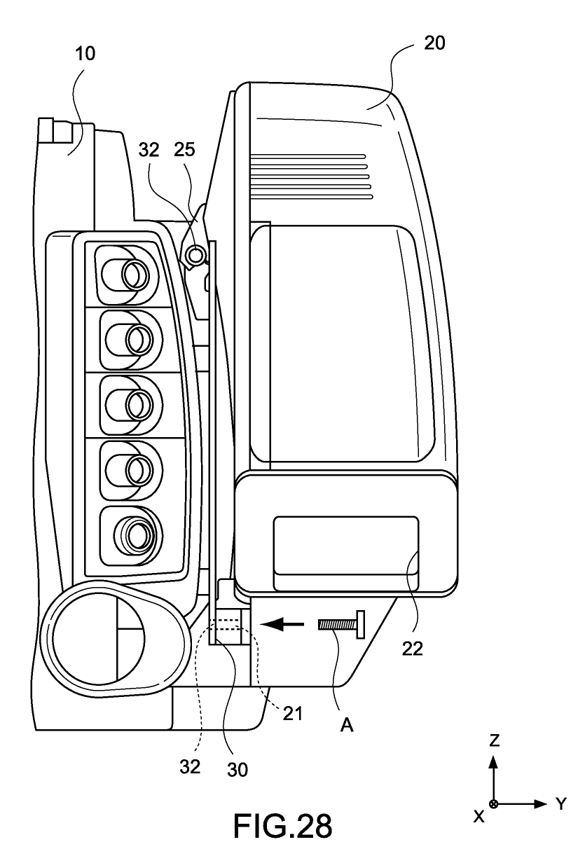

Next, as shown in FIG. 27, the noise cancellation unit 20 is rotated about the shaft 32 serving as a rotation axis so as to come into contact with the bracket 30 as shown in FIG. 28. At that time, if the orientation of the camera 10 is adjusted such that the shaft 32 is set in a horizontal direction, when the hook 25 is hooked to the shaft 32 and then a hand is released, the noise cancellation unit 20 is spontaneously rotated and the screw holes 21 provided in the noise cancellation unit 20 are aligned with the female screws 33 of the bracket 30.

Subsequently, as shown in FIG. 28 and FIG. 29, the screw holes 21 and the female screws 33 are fastened with screws A. Since the noise cancellation unit 20 is engaged with the shaft 32 through the hook 25, screwing can be performed without adjusting positions of the screw holes 21. As shown in FIG. 30, the elastic member 24 (see FIG. 8) is elastically deformed by the screwing, with the result that the casing inlet 23 comes into close contact with the outlet 11. In other words, the duct inlet 209 comes into close contact with the outlet 11. Therefore, the noise cancellation effect produced by the noise cancellation unit 20 can be effectively exerted.

The noise cancellation unit 20 according to this embodiment is configured as described above. With the noise cancellation unit 20, active noise cancellation can be performed on an exhaust air discharged from the outlet 11 of the camera 10. Further, since the noise cancellation unit 20 is detachable from the camera 10, the noise cancellation unit 20 can be fitted on the camera 10 as necessary.

The present disclosure is not limited to the embodiment described above and can be modified without departing from the gist of the present disclosure.

The noise cancellation unit according to the embodiment described above is fitted on a video shooting camera, but in addition thereto, the noise cancellation unit can be fitted on an electronic apparatus necessary to prevent a noise from being generated.

In the embodiment described above, the noise cancellation unit is fixed to the bracket by screwing, but a fixing means is not limited thereto. For example, the noise cancellation unit can be fixed to the bracket by a detachable fixing means such as a catch clip.

It should be noted that the present disclosure can also take the following configurations.

(1) A noise cancellation unit, including:

a duct connected to an outlet of an electronic apparatus and configured to pass an exhaust flow discharged from the outlet therethrough;

a first microphone provided to the duct;

a speaker provided to the duct downstream of the first microphone;

a second microphone provided to the duct downstream of the speaker;

a first windscreen wall configured to prevent the exhaust flow from colliding with the first microphone;

a second windscreen wall configured to prevent the exhaust flow from colliding with the second microphone; and

a signal processing circuit configured to generate, based on outputs of the first microphone and the second microphone, a sound signal for removing a noise included in the exhaust flow and supply the sound signal to the speaker.

(2) The noise cancellation unit according to Item (1), further including a sound guide wall configured to guide a sound emitted from the speaker toward a downstream side of the duct.

(3) The noise cancellation unit according to Item (1) or (2), in which

the duct is extended in a first direction, bent to be inverted in a second direction orthogonal to the first direction, and extended in a third direction opposite to the first direction, the duct having a cross-sectional surface whose aspect ratio is gradually varied through the inversion.

(4) The noise cancellation unit according to any one of Items (1) to (3), in which

the first windscreen wall is continuous to an inner wall of the duct upstream of the first microphone and has a shape for shielding the first microphone from an upstream side of the duct, and

the second windscreen wall is continuous to the inner wall of the duct upstream of the second microphone and has a shape for shielding the second microphone from the upstream side of the duct.

(5) The noise cancellation unit according to any one of Items (1) to (4), in which

the sound guide wall is continuous to the inner wall of the duct upstream of the speaker and has a shape for covering the speaker from the upstream side of the speaker to a front of the speaker.

(6) A noise cancellation unit, including:

a noise cancellation unit main body including a duct connected to an outlet of a camera and configured to pass an exhaust flow discharged from the outlet therethrough,

a first microphone provided to the duct, a speaker provided to the duct downstream of the first microphone,

a second microphone provided to the duct downstream of the speaker, and

a signal processing circuit configured to generate, based on outputs of the first microphone and the second microphone, a sound signal for removing a noise included in the exhaust flow and supply the sound signal to the speaker; and

a fixing unit configured to detachably fix the noise cancellation unit main body to the camera such that the duct is connected to the outlet.

(7) The noise cancellation unit according to Item (6), in which

the fixing unit fixes the noise cancellation unit main body to the camera via a bracket connected to the camera.

(8) The noise cancellation unit according to Item (6) or (7), in which

the fixing unit includes

a casing configured to accommodate the noise cancellation unit main body,

a hook provided to the casing and configured to be rotatably engaged with a shaft provided to the bracket, and

a screw hole provided to the casing and through which the noise cancellation unit is screwed to the bracket.

(9) The noise cancellation unit according to any one of Items (6) to (8), in which

the duct is connected to the outlet via an elastic member.

(10) The noise cancellation unit according to any one of Items (6) to (9), in which

the fixing unit includes

a casing configured to accommodate the noise cancellation unit main body,

a hook provided to the casing and configured to be rotatably engaged with a shaft provided to the camera, and

a screw hole provided to the casing and through which the noise cancellation unit is screwed to the camera.

It should be understood by those skilled in the art that various modifications, combinations, sub-combinations and alterations may occur depending on design requirements and other factors insofar as they are within the scope of the appended claims or the equivalents thereof.

What is claimed is:

1. A noise cancellation unit, comprising:
a duct connected to an outlet of an electronic apparatus and configured to pass an exhaust flow discharged from the outlet therethrough;
a first microphone provided to the duct;
a speaker provided to the duct downstream of the first microphone;
a second microphone provided to the duct downstream of the speaker;
a first windscreen wall configured to prevent the exhaust flow from colliding with the first microphone;
a second windscreen wall configured to prevent the exhaust flow from colliding with the second microphone; and
a signal processing circuit configured to generate, based on outputs of the first microphone and the second microphone, a sound signal for removing a noise included in the exhaust flow and supply the sound signal to the speaker.

2. The noise cancellation unit according to claim 1, further comprising a sound guide wall configured to guide a sound emitted from the speaker toward a downstream side of the duct.

3. The noise cancellation unit according to claim 2, wherein
the duct is extended in a first direction, bent to be inverted in a second direction orthogonal to the first direction, and extended in a third direction opposite to the first direction, the duct having a cross-sectional surface whose aspect ratio is gradually varied through the inversion.

4. The noise cancellation unit according to claim 3, wherein
the first windscreen wall is continuous to an inner wall of the duct upstream of the first microphone and has a shape for shielding the first microphone from an upstream side of the duct, and
the second windscreen wall is continuous to the inner wall of the duct upstream of the second microphone and has a shape for shielding the second microphone from the upstream side of the duct.

5. The noise cancellation unit according to claim 4, wherein
the sound guide wall is continuous to the inner wall of the duct upstream of the speaker and has a shape for covering the speaker from the upstream side of the speaker to a front of the speaker.

6. A noise cancellation unit, comprising:
a noise cancellation unit main body including
a duct connected to an outlet of a camera and configured to pass an exhaust flow discharged from the outlet therethrough,
a first microphone provided to the duct,
a speaker provided to the duct downstream of the first microphone,
a second microphone provided to the duct downstream of the speaker, and
a signal processing circuit configured to generate, based on outputs of the first microphone and the second microphone, a sound signal for removing a noise included in the exhaust flow and supply the sound signal to the speaker; and
a fixing unit configured to detachably fix the noise cancellation unit main body to the camera such that the duct is connected to the outlet.

7. The noise cancellation unit according to claim 6, wherein
the fixing unit fixes the noise cancellation unit main body to the camera via a bracket connected to the camera.

8. The noise cancellation unit according to claim 7, wherein
the fixing unit includes
a casing configured to accommodate the noise cancellation unit main body,
a hook provided to the casing and configured to be rotatably engaged with a shaft provided to the bracket, and
a screw hole provided to the casing and through which the noise cancellation unit is screwed to the bracket.

9. The noise cancellation unit according to claim 8, wherein
the duct is connected to the outlet via an elastic member.

10. The noise cancellation unit according to claim 6, wherein
the fixing unit includes
a casing configured to accommodate the noise cancellation unit main body,
a hook provided to the casing and configured to be rotatably engaged with a shaft provided to the camera, and
a screw hole provided to the casing and through which the noise cancellation unit is screwed to the camera.
